(19) United States
(12) Patent Application Publication
(10) Pub. No.: US 2006/0198693 A1
(43) Pub. Date: Sep. 7, 2006

(54) Joint lug for a piston-cylinder unit

(75) Inventors: Gunther Handke, Euerbach (DE); Janine Bull, Berlin (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG, Friedrichshafen (DE)

(21) Appl. No.: 11/365,311

(22) Filed: Mar. 1, 2006

(30) Foreign Application Priority Data
Mar. 1, 2005 (DE) 10 2005 009 152.0

(51) Int. Cl. F16L 41/00

(52) U.S. Cl. 403/230

(57) ABSTRACT

Joint lug for a piston-cylinder unit includes a tubular body which is formed as one piece with a right-angle web, in which a through-opening for a fastening connector is provided. The right-angle web includes a support web having at least one tab which is supported against the tubular body.

### BACKGROUND OF THE INVENTION

1. Field of the Invention

The invention pertains to a joint lug having a web for fastening to a piston-cylinder unit.

2. Description of the Related Art

U.S. Pat. No. 6,827,519 describes a joint lug formed out of a flat sheet metal blank for a piston-cylinder unit. Two tubular bodies formed from the sheet metal blank are connected by a web, in which a threaded bore is produced to accept a piston rod. The facing end surfaces of the two tubular bodies are in contact with each other. A basic problem with a joint lug of this design is that small inaccuracies in the bending work lead to an angular offset between the two tubular bodies. This angular offset makes it more difficult to install an elastomeric body in the tubular bodies to pretension them.

At first glance, one solution to the problem described above would be to subject the finished, shaped tubular body to a machining operation. This, however, would negate the cost advantage of the component. Alternatively, the joint lug could be restruck afterwards, but this, too, would introduce an additional processing step.

### SUMMARY OF THE INVENTION

An object of the present invention is to take a joint lug in the form of a component shaped by bending and to improve it in such a way that it can be produced at low cost and can also absorb high loads.

According to the invention, the right-angle web is formed as one piece with a support web, which rests against the tubular body.

The one-piece design of the tubular body eliminates from the very beginning the problem of the state of the art described above. The support web also prevents the joint lug from assuming a slanted position with respect to the piston-cylinder unit under the action of high loads.

In another advantageous embodiment, the support web is welded to the tubular body. The support web can therefore absorb both tensile and compressive forces and significantly increases the strength of the joint lug.

The right-angle web and the support web preferably form a U-shaped component, which extends in the longitudinal direction of the tubular body. A single weld is sufficient in this case to connect the U-shaped component to the tubular body.

In an alternative embodiment, the support web extends transversely to the right-angle web.

It has been found to be especially advantageous for the support web to be formed by a U-shaped profile. The U-shaped profile makes it possible to use very sturdy forming tools.

Preliminary series of tests have shown that especially good dimensional stability can be achieved when the width of the U-shaped profile is equal to approximately half the inside diameter of the tubular body.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a front perspective view of a joint lug with a U-shaped web;

FIG. 2 is a rear perspective view of a joint lug with a U-shaped web;

FIG. 3 shows a sheet metal blank for a joint lug according to FIG. 1; and

FIGS. 4-7 show an alternative embodiment of the joint lug according to the invention.

### DETAILED DESCRIPTION OF THE PRESENTLY PREFERRED EMBODIMENTS

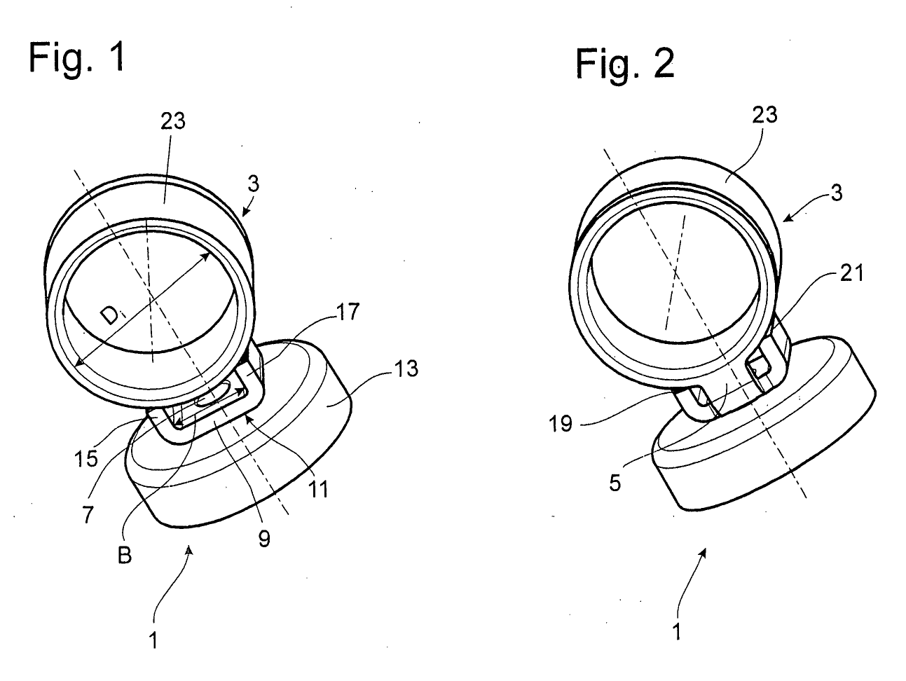

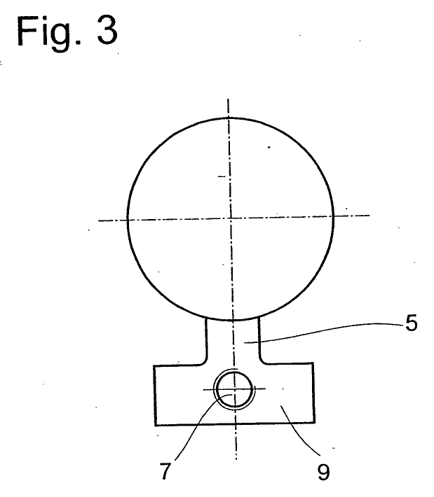

FIGS. 1 and 2 show a joint lug 1 for a piston-cylinder unit (not shown), e.g., a shock absorber. The joint lug consists of a one-piece tubular body 3, which is produced by a drawing process from a flat sheet metal blank according to FIG. 3. A right-angle web 5 extends seamlessly from the same sheet metal blank and has a through-opening 7 for a fastening connector. The through-opening can be provided, for example, with a thread for a piston rod of the piston-cylinder unit. A support web 9 is integrally connected to the angle web 5. In the present embodiment, the support web extends transversely to the angle web. The support web 9 is formed by a U-shaped profile, the base surface 11 of which is attached to a support disk 13 for a protective tube of the piston-cylinder unit. The end surfaces of vertical tabs 15, 17 of the support web 9 are attached by welds 19, 21 to the outside lateral surface 23 of the tubular body 3. The width B of the U-shaped profile is preferably equal to approximately half the inside diameter Dᵢ of the tubular body 3.

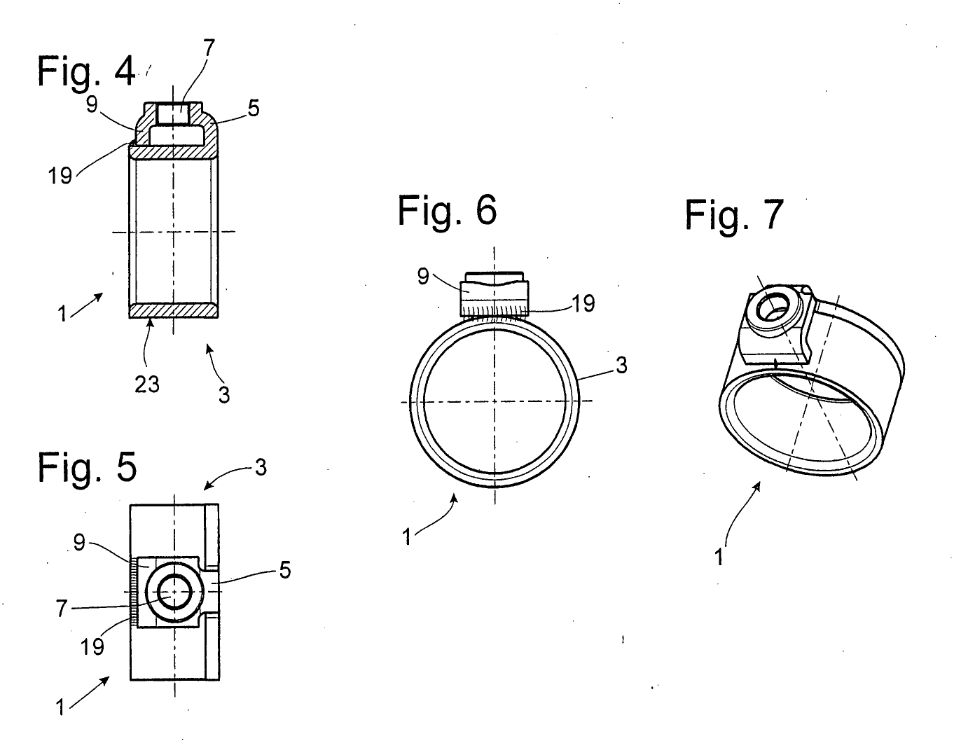

FIGS. 4-7 show a solution for a joint lug 1 which is even simpler than that of FIGS. 1 and 2. FIG. 4 shows a cross-sectional view of the tubular body 3, which has a right-angle web 5 as an integral part. The support web 9 proceeds from the right-angle web 5 and thus extends in the longitudinal direction of the tubular body. The right-angle web 5 and the support web 9 form a U-shaped component. In comparison to the design of FIGS. 1 and 2, the goal is achieved that the support web 9 can be attached to the outside lateral surface 23 of the tubular body 3 by only a single weld 19, which results in a further lowering of costs.

The connection of a support web 9, which is formed as one piece with the right-angle web 5, to the tubular body 13 makes it possible for the right-angle web to absorb comparatively high loads.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A joint lug for a piston-cylinder unit, the joint lug comprising:
a tubular body;
a right angle web formed as one piece with the tubular body; and
a support web formed as one piece with the right angle web and supported against the tubular body.

2. The joint lug of claim 1 wherein the support web is welded to the tubular body.

3. The joint lug of claim 1 wherein the right-angle web and the support web together have a U-shaped profile, the support web being formed with a tab which is parallel to the right angle web.

4. The joint lug of claim 1 wherein the support web extends transversely to the right angle web.

5. The joint lug of claim 1 wherein the support web has a U-shaped profile, the support web being formed with upstanding parallel tabs which are supported against the tubular body.

6. The joint lug of claim 5 wherein the tabs are spaced apart by a distance approximately equal to half the diameter of the tubular body.
